(19) United States
(12) Patent Application Publication
(10) Pub. No.: US 2026/0200175 A1
(43) Pub. Date: Jul. 16, 2026

(54) SEAT REST FOR CHAIR WITH 3D PRINT LATTICE STRUCTURE ZONAL COMPLIANCE

(71) Applicant: Autonomous Inc., Riverside, CA (US)

(72) Inventors: Hung Nguyen, Ho Chi Minh City (VN); Uyen Le, Ho Chi Minh City (VN); Y Nguyen, Ho Chi Minh City (VN); Nam Mai, Ho Chi Minh City (VN); Duc Pham, Ho Chi Minh City (VN); Hoang Ho, Ho Chi Minh City (VN); Thanh Tran, Ho Chi Minh City (VN); Long Ha, Ho Chi Minh City (VN)

(21) Appl. No.: 19/016,878

(22) Filed: Jan. 10, 2025

(51) Int. Cl. B29C 64/386; A47C 7/02; B33Y 50/00; B33Y 80/00; G06F 30/13; G06F 119/14

(52) U.S. Cl. CPC B29C 64/386; A47C 7/029; G06F 30/13; B33Y 50/00; B33Y 80/00; G06F 2119/14

(57) ABSTRACT

A seat rest design system including a memory configured to store seat rest data, wherein the seat rest data includes one or more sitting pressure values and a processor operatively coupled to the memory, wherein the processor is configured to analyze the one or more sitting pressure values and generate a lattice structure design for a seat rest base using the analysis of the one or more sitting pressure values, the lattice structure design being configured to provide additional support in portions of the lattice structure design based on the sitting pressure values.

### BACKGROUND

A seat is a contact point of a chair that supports at least a portion of the weight of a person sitting in the chair. A primary design consideration for a seat rest is the amount of comfort it provides to the sitter. To improve overall comfort, some traditional seats include built in suspension (e.g., springs) that helps to absorb the impact experienced by the sitter. Other design considerations include the overall weight of the seat, the aesthetic appearance of the seat, the ease of manufacturing the seat, the amount of difficulty involved in making seat adjustments by the sitter, etc.

### SUMMARY

In some aspects, the techniques described herein relate to a seat rest design system including: a memory configured to store seat rest data, wherein the seat rest data includes one or more sitting pressure values; and a processor operatively coupled to the memory, wherein the processor is configured to: analyze the one or more sitting pressure values; and generate a lattice structure design for a seat rest base using the analysis of the one or more sitting pressure values, the lattice structure design being configured to provide additional support in portions of the lattice structure design based on the sitting pressure values.

In some aspects, the techniques described herein relate to a seat rest design system, wherein the one or more sitting pressure values include desired pressure values for a plurality of seat rest zones.

In some aspects, the techniques described herein relate to a seat rest design system, further including a transceiver operatively coupled to the processor, wherein the transceiver is configured to receive at least a portion of the seat rest data from a seat rest sensor system.

In some aspects, the techniques described herein relate to a seat rest design system, wherein analysis of the one or more sitting pressure values identifies an area of peak sitting pressure.

In some aspects, the techniques described herein relate to a seat rest design system, wherein the processor determines whether the area of peak sitting pressure exceeds a pressure threshold.

In some aspects, the techniques described herein relate to a seat rest design system, wherein the processor generates a pressure reduction goal for the area of peak sitting pressure that exceeds the pressure threshold, wherein the processor uses the pressure reduction goal to generate the lattice structure design with reduced pressure at the area of peak sitting pressure, and wherein the reduced pressure is within the pressure threshold.

In some aspects, the techniques described herein relate to a seat design system, wherein the processor is configured to generate a pressure map based at least in part on the analysis of the one or more sitting pressure values.

In some aspects, the techniques described herein relate to a seat rest design system, wherein generation of the lattice structure design includes generation of instructions for a three-dimensional (3D) printer to print the lattice structure design.

In some aspects, the techniques described herein relate to a seat rest design system, wherein to generate the lattice structure design the processor determines a thickness of one or more ribs that form the lattice structure design and a length of the one or more ribs that form the lattice structure design.

In some aspects, the techniques described herein relate to a seat rest design system, wherein to generate the lattice structure design the processor determines a type of shape that is to be formed by interconnected ribs that form the lattice structure design, and wherein to generate the lattice structure design the processor determines a size of an opening in the type of shape formed by the interconnected ribs that form the lattice structure design.

In some aspects, the techniques described herein relate to a seat rest including: a seat rest shell; and a seat rest base mounted to the seat rest shell, wherein the seat rest base is in the form of a lattice structure that includes: a first zone composed of a first plurality of interconnected ribs that result in a first peak sit pressure value for the first zone; and a second zone composed of a second plurality of interconnected ribs that result in a second peak sit pressure value for the second zone that differs from the first peak sit pressure value.

In some aspects, the techniques described herein relate to a seat rest, wherein at least a portion of the first plurality of interconnected ribs form a first plurality of shapes having first openings, and wherein at least a portion of the second plurality of interconnected ribs form a second plurality of shapes having second openings.

In some aspects, the techniques described herein relate to a seat rest, wherein the first openings differ in size from the second openings.

In some aspects, the techniques described herein relate to a seat rest, wherein the first plurality of shapes are of a different type than the second plurality of shapes.

In some aspects, the techniques described herein relate to a seat rest 14, wherein a first portion of the first plurality of interconnected ribs form a first plurality of shapes having first openings, wherein a second portion of the first plurality of interconnected ribs form a second plurality of shapes having second openings, and wherein the first openings differ in size from the second openings.

In some aspects, the techniques described herein relate to a multi-zonal sitting structure including: a seat rest base; a seat rest lattice structure positioned on a top surface of the seat rest base, wherein the seat rest lattice structure is a 3D printed lattice with a first zone having a first sitting pressure and a second zone having a second sitting pressure; and one or more leg supports connected to a bottom surface of the seat rest base to support the seat rest base.

In some aspects, the techniques described herein relate to a muti-zonal sitting structure, wherein the seat rest lattice structure is 3D printed using a generated lattice structure design that includes a plurality of interconnected ribs forming the first zone and the second zone.

In some aspects, the techniques described herein relate to a multi-zonal sitting structure, wherein the plurality of interconnected ribs form a first plurality of shapes having first openings, and wherein at least a portion of the second plurality of interconnected ribs form a second plurality of shapes having second openings.

In some aspects, the techniques described herein relate to a multi-zonal sitting structure, wherein the first zone is designed to provide more support based on the first zone being identified as a higher pressure sitting area.

In some aspects, the techniques described herein relate to a multi-zonal sitting structure, wherein the second zone is designed to provide less support compared to the first zone support based on the second zone being identified as a lower pressure sitting area.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a chair with a seat constructed using zonal compliance in accordance with an illustrative embodiment.

FIG. 2 depicts a seat design system in accordance with an illustrative embodiment.

FIG. 3 depicts a seat base with lattice in accordance with an illustrative embodiment.

FIG. 4A depicts an initial pressure map generated on a seat and based on sensor data in accordance with an illustrative embodiment.

FIG. 4B depicts the pressure map for a seat designed using the seat design application based on pressure reduction goals in accordance with an illustrative embodiment.

FIG. 5A depicts a seat divided into zones in accordance with an illustrative embodiment.

FIG. 5B depicts an exploded view of a seat divided into zones in accordance with an illustrative embodiment.

FIG. 6 depicts a seat with custom compliance zones in accordance with an illustrative embodiment.

FIG. 7 is a flow diagram depicting operations performed to make a seat in accordance with an illustrative embodiment.

FIG. 8A is a plot that depicts median peak values of pressure extracted from seat data in accordance with an illustrative embodiment.

FIG. 8B depicts a pressure map in accordance with an illustrative embodiment.

FIG. 8C depicts the pressure map superimposed on a seat in accordance with an illustrative embodiment.

### DETAILED DESCRIPTION

Different users may have differing experiences when sitting on a same or similar seat rest due to sitting style and other factors. For example, some users tend to sit more towards the front of the seat rest, some users tend to sit more towards the rear of the seat rest, and other users tend to sit in the middle of the seat rest. The weight, shape, size, injury history, etc. of the user can also affect how he/she experiences the seat rest. Described herein is a seat rest that is designed and constructed such that different areas of the seat rest have different compliance to improve overall comfort of the user, as compared to traditional seat rests. Specifically, the proposed seat rest can provide in some embodiments in excess of a 50% reduction in peak pressure (between the user and the seat rest) as compared to traditional seat rests. Using the techniques described herein, different seat rests can be designed for different types of individual users, such that comfort is maximized for all users. Also described herein are systems for designing seat rests based on desired seat rest characteristics.

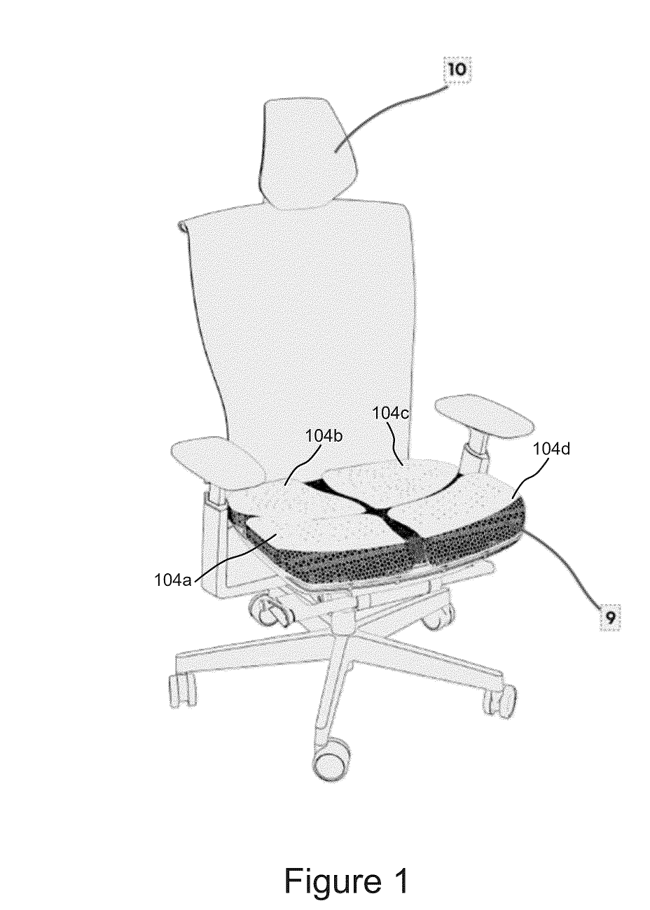

FIG. 1 depicts a chair 10 with a seat rest 9 constructed using zonal compliance in accordance with an illustrative embodiment. As used herein, zonal compliance refers to the controlled variation of seat rest compliance across a plurality of zones 104 into which the seat rest 9 is divided. As shown in the example in FIG. 1, the seat rest 9 is divided into four separate zones 104a-104d. In alternative embodiments, the compliance of the seat rest can be controlled without the use of separate zones.

In an illustrative embodiment, the seat rest 9 of the chair 10 can be generated using a design system. The design system may generate seat designs that can be generated for different users or different sitting experiences, which can be used to make corresponding seat rests 9 through three-dimensional (3D) printing and/or other fabrication techniques. The design system can be used to a generate custom seat rest for an individual sitters and/or mass market designs tailored to different groups of sitters based on sitting style, sitter size, sitter weight, sitter sex, pre-existing injuries, etc.

As discussed in more detail below, the seat design system can utilize a sensor system, such as a sensor system integrated into a hardware device in some scenarios to detect pressure areas that result. These pressures areas can mimic the pressure areas a sitter may have when a sitter sits upon a seat rest. These pressure areas can be identified for each of a plurality of zones 104 of the seat, or generally for the seat as a whole. This pressure data may then be fed into a computer algorithm, where it can be analyzed by a human user and/or an automated algorithm (such as AI or machine learning algorithms) to identify any areas of concern (e.g., areas in which the pressure between the sitter and the seat exceeds a pressure threshold). Areas of concern can also be identified based on sitter feedback. Based on the identified areas of concern, a pressure reduction goal may be determined or set for each identified area, and the reduction goals and original pressure data are then fed into a seat design application (or algorithm). The seat rest design algorithm may use the pressure data and reduction goals to generate a seat rest design that results in reduced pressure in the areas of concern in accordance with the reduction goals.

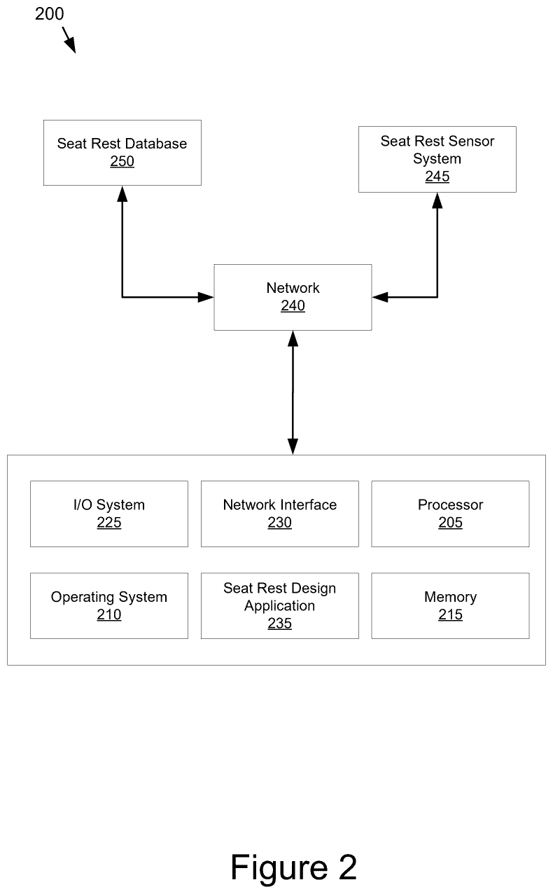

FIG. 2 depicts a seat rest design system 200 in accordance with an illustrative embodiment. The seat rest design system 200 is in the form of a computing system that includes a processor 205, an operating system 210, a memory 215, an I/O system 225, a network interface 230, and a seat rest design application 235. In alternative embodiments, the seat rest design system 200 may include fewer, additional, and/or different components. The components of the seat rest design system 200 communicate with one another via one or more buses or any other interconnect system. In an illustrative embodiment, the seat rest design system 200 can be part of a laptop computer, desktop computer, tablet, etc. The seat rest design system 200 may be in communication with a seat rest sensor system 245 that may included a plurality of sensors as described elsewhere herein and a seat rest data database 250 via a network 240. In an alternative embodiment, the seat rest design system 200 may be in direct (wired) communication with the seat rest sensor system 245 and/or the seat rest data database 250. In another alternative embodiment, the seat rest design system 200 may operate independent of the seat rest sensor system 245 and/or the seat rest database 250.

The processor 205 can be any type of computer processor known in the art, and can include a plurality of processors and/or a plurality of processing cores. The processor 205 can include a controller, a microcontroller, an audio processor, a graphics processing unit, a hardware accelerator, a digital signal processor, etc. Additionally, the processor 205 may be implemented as a complex instruction set computer processor, a reduced instruction set computer processor, an x86 instruction set computer processor, etc. The processor 205 may be used to run the operating system 210, which can be any type of operating system.

The operating system 210 may be stored in the memory 215, which may also be used to store programs, network and communications data, peripheral component data, the seat rest design application 235, and/or other operating instructions. The memory 215 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In an alternative embodiment, the seat rest database 250 can be part of the memory 215.

The I/O system 225 may be the framework which enables users and/or peripheral devices to interact with the seat rest design system 200. The I/O system 225 can include a mouse, a keyboard, one or more displays, one or more touchscreens, a speaker, a microphone, etc. that allow the user to interact with and control the seat rest design system 200. The I/O system 225 may also include circuitry and/or a bus structure to interface with peripheral computing devices such as power sources, USB devices, peripheral component interconnect express (PCIe) devices, serial advanced technology attachment (SATA) devices, high definition multimedia interface (HDMI) devices, proprietary connection devices, etc. In an illustrative embodiment, the I/O system 225 is configured to receive inputs and operating instructions from a user.

The network interface 230 may include transceiver circuitry that allows the seat rest design system 200 to transmit and/or receive data to/from other devices such as remote computing systems, servers, websites, the seat rest sensor system 245, the seat rest database 250, etc. The network interface 230 can enable communication through the network 240, which can be in the form of one or more communication networks and devices. For example, the network 240 can include a cable network, a fiber network, a cellular network, a wi-fi network, a landline telephone network, a microwave network, a satellite network, etc. and any devices/programs accessible through such networks. The network interface 230 can also include circuitry to allow device-to-device communication such as Bluetooth communication.

The seat rest design application 235 may include hardware and/or software that may be configured to perform any of the operations described herein to design a seat rest. Software of the seat rest design application 235 can be stored in the memory 215. The seat rest design application 235 can be used to generate a seat rest design based on seat rest data that is received through the seat rest sensor system 245 and/or the seat rest database 250. Alternatively, the seat rest data can be received through user input and/or from any other source.

The seat rest sensor system 245 is a system that may include a plurality of pressure sensors incorporated therein or thereon. In one embodiment, the plurality of pressure sensors can be attached to or formed into a seat cover that mounts to the seat base. Alternatively, the plurality of pressure sensors can be mounted to or formed into the seat base. The sensors can be individual sensors or in the form of a continuous sensor sheet, depending on the embodiment. In an illustrative embodiment, a sitter can sit on the seat rest sensor system 245 and pressure readings can be obtained to identify the amount of pressure between the sitter and the seat at multiple points of contact therebetween. For example, in one embodiment, 1440 sensor readings can be obtained. Alternatively, fewer or additional sensor readings may be used, such as 500, 1000, 1500, 2000, 3000, etc. In another alternative embodiment, pressure readings may be obtained for only a portion of the areas of contact between the sitter and the seat rest sensor system 245. For example, the pressure readings may be only from one or more specific zones into which the seat rest is divided. In another embodiment, the pressure readings can result from the interaction of a simulated sitter (e.g., a robot or robotic arm) and the seat rest sensor system 245. Each of the pressure readings has an associated location that represents where on the seat rest the pressure reading was sensed. These pressure readings and associated locations on the seat rest form seat rest data that is used by the seat rest design application 235 to generate a seat rest design.

For example, a sitter that is experiencing discomfort while sitting on a conventional seat rest can sit on the pressure sensors of the seat rest sensor system 245. While the sitter is on the seat rest sensor system 245, the sensors can identify the areas of contact between the sitter and the seat and the amount of pressure at these areas. In an illustrative embodiment, the pressure may be measured in Newtons/millimeter2 (N/mm2). Alternatively, a different pressure unit may be used such as Pascals, etc. The processor 205 can use the data from the sensors to generate a pressure map that indicates the amount of pressure sensed at each area (or point) of contact between the sitter and the seat rest. As discussed herein, the seat rest data can also come from simulated sitter-seat interactions, from stored data, from direct user feedback, etc.

The sensor data can be analyzed to identify high pressure contact areas between the sitter and the seat rest. Such high pressure contact areas can be identified as problem areas if the amount of detected pressure exceeds a pressure threshold. For example, the pressure threshold, which can be 5 N/mm2, 10N/mm2, 12N/mm2, 15N/mm2, 18N/mm 2, 20N/mm2, etc. can vary for different sitters, for different zones of the seat rest, and/or different groups of sitters. Direct feedback from the user can also be used to identify problem areas and other areas of concern for the sitter. For example, the sitter may have an injury or condition that results in pain from a relatively low pressure contact area between the sitter and the seat rest. Such areas can be identified by the sitter and input into the system. In another example, various artificial intelligence or machine learning algorithms may be used to determine problem areas based on information about the sitter, such as injuries, conditions, weight profiles, height profiles, sitting positions, etc.

Once problem areas are identified, either automatically by the system or via input from the user, the system and/or a user can set one or more pressure reduction goals. Each pressure reduction goal indicates an amount by which pressure is to be reduced at a given area of the seat rest (i.e., at a given contact area between the sitter and the seat rest). The pressure reduction goals can be in terms of a percentage reduction in pressure (e.g., a 5% pressure reduction, a 10% pressure reduction, a 20% pressure reduction, etc.) or an outright reduction in pressure (e.g., 5 less N/mm2, 10 less N/mm2, etc.).

In some embodiments, the pressure reduction goals can be set automatically by the system, such as by generating one or more pressure reduction goals, etc. For example, the system may automatically aim to reduce the peak pressure in a given zone (e.g., any zone of the seat rest) or all zones on the seat rest by a given percentage (e.g., 5%, 10%, 20%, etc.). Different zones and/or areas of the seat rest can have different reduction goals. The pressure reduction goals can also be based on sitter feedback based on where he/she is experiencing discomfort or looking for improvement in comfort. For example, the sitter can specify a percentage reduction (or outright pressure reduction) in one or more areas of the seat rest based on his/her experience and/or the pressure map associated with the sitter experience.

In some implementations, the pressure reduction goals and seat rest data (i.e., from the sensors and/or from the database) are provided to the seat rest design application 235, which may programmed to determine a design for a seat rest base in the form of a lattice. As used herein, the seat rest base and the lattice are one and the same. Additional information can also be provided to the seat rest design application 235 such as sitter weight, sitter size, characteristics of the material used to form the seat rest base, the material from which the seat rest shell is made, etc. The lattice design, once turned into a seat rest, will result in a seat rest base that has reduced sitter-seat pressure in accordance with the pressure reduction goals. In an illustrative embodiment, the lattice design is in the form of instructions for a 3D printer, and the 3D printer can be used to print a seat rest base that matches the lattice design.

In another illustrative embodiment, the lattice design (and the resulting seat rest base) is in the form of interconnected ribs (or struts). The ribs can form interconnected polygons, such as 3-sided shapes, 4-sided shapes, 5-sided shapes, 6-sided shapes, 8-sided shapes, 10-sided shapes, etc. Alternatively, the ribs can be in the form of continuous shapes such as circles, ovals, etc. The seat rest design application 235 controls the compliance (or flexibility) of the seat rest based on the hardness and flexibility of the material used to form the seat rest and other factors. Specifically, the seat rest design application 235 controls the thickness, shape, orientation, cross-sectional profile, and/or length of the ribs to impart the desired amount of compliance at each area (or zone 104) of the seat rest based on the seat rest data, the pressure reduction goals, known characteristics of the material used to form the seat rest, etc. The material used to form the seat rest can be an elastomeric polyurethane (EPU) (e.g., EPU44), a thermoplastic polyurethane (TPU) (e.g., TPU1301), or any other type of 3D printer material known in the art. In an alternative embodiment, the seat base may be fabricated from a technique other than 3D printing and/or from a material other than a type of plastic.

In some embodiments, a strain rate hardening material may be used to construct the seat rest base. An example of such a material is Rheon by RheonLabs. A strain rate hardening material is designed to stiffen as it gets impacted. Such materials can be made of strain-rate sensitive polymers that temporarily stiffen in response to an impact or other energy absorbing occurrence. This property allows for increased energy absorption by the material (e.g., seat rest base), which results in less force transmitted into the sitter that is in contact with the seat rest base. This translates into a more comfortable sitting experience for the sitter. When used to form a seat rest base, the geometry of the polymers that make up the material can be controlled by the seat rest design application 235 to determine the amount of energy absorption at each zone or other desired area of the seat rest base. Specifically, the seat rest design application 235 can determine the amount of compliance that the strain rate hardening material will provide at each location of the seat rest, taking into consideration the additional energy absorption afforded by the strain-rate sensitive nature of the material. A seat rest formed with a strain rate hardening material can be made via 3D printing as described herein. Alternatively, the system can generate a design to form the seat rest base with the strain rate hardening material through injection molding.

In one embodiment, the seat rest design application 235 can use an iterative process to design a seat rest. The iterative process can include having the seat rest design application 235 design a lattice, simulate what the compliance of the seat rest will be for a sitter, compare the simulated compliance to a desired target compliance (i.e., based on the original seat data and the reduction goal(s)), adjust the lattice design based on the present and past simulation results in an effort to achieve the target compliance, and continue this process until the target compliance is achieved for the seat rest. The target compliance can be a plurality of compliance values (or reductions in pressure values) corresponding to a plurality of locations on the seat rest. In an illustrative embodiment, the seat rest can be divided into zones 104 and compliance values for each zone 104 can be considered independently in the iterative process.

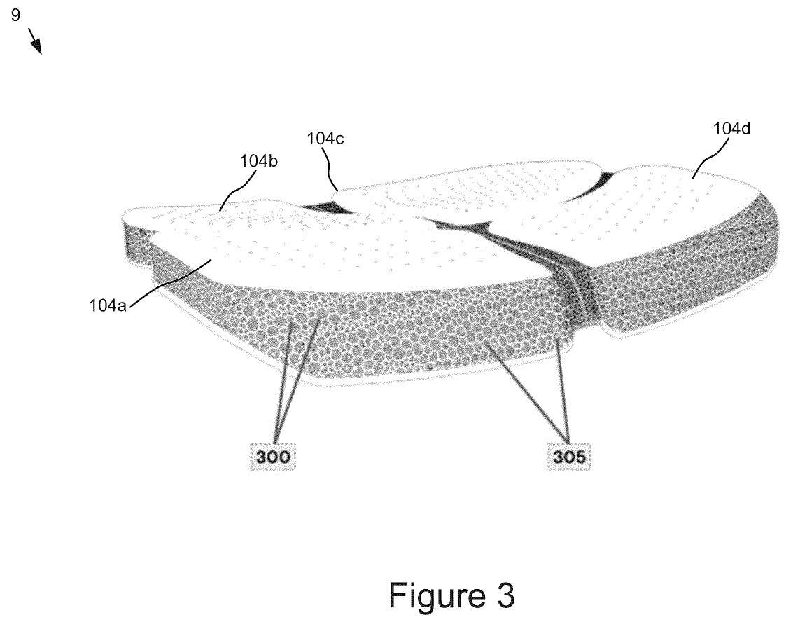

FIG. 3 depicts a printed seat rest base 9 (or lattice) in accordance with an illustrative embodiment. As shown the seat rest base 9 is formed from a plurality of interconnected ribs 300 that form interconnected polygons. As shown in FIG. 3, at least a portion of the polygons may be hexagon in shape, although different shapes can be used in alternative embodiments as described herein. In an illustrative embodiment, a cross-section of each of the individual ribs 300 can be circular (i.e., the ribs are cylindrical in shape). Alternatively, the ribs 300 can have a different cross-sectional profile such as triangular, square, rectangular, ovular, pentagonal, etc. In some embodiment, different ribs in a given seat rest base 9 can have different cross-sectional profiles to control the overall compliance of the seat rest base 9. As also shown, the interconnected ribs 300 form openings 305 (a few of which have been pointed out with reference number 305, although other openings are also illustrated without having reference number 305) having the shape of the polygon (or other shape) formed by the interconnected ribs. For example, in the embodiment of FIG. 3, the openings are triangular in shape. In alternative embodiments, different polygons can be used, resulting in different shaped openings. By controlling a size (e.g., diameter) of the ribs, a length of the ribs, a type of polygon formed by the ribs, a cross-sectional shape of the ribs, a size of the openings formed by the ribs, and/or the material used to form the ribs, the seat rest design application 235 can control the compliance in different areas of the seat rest 9 as described herein.

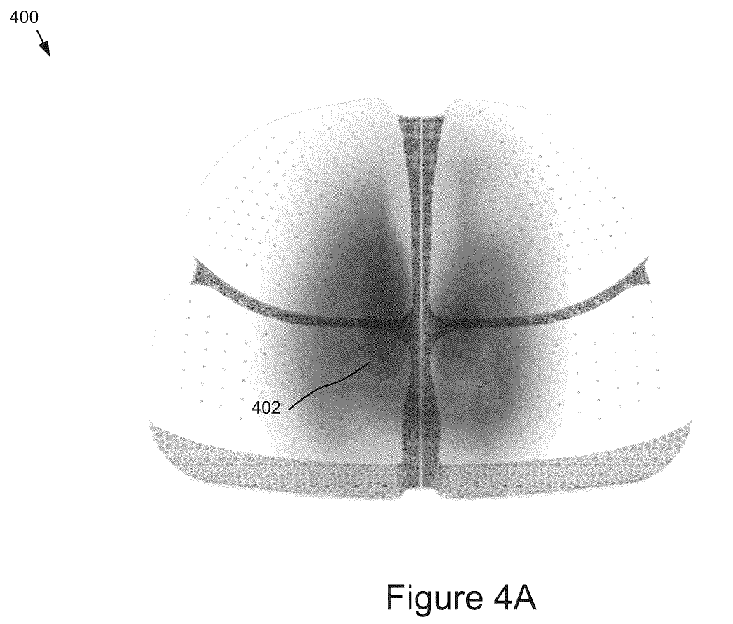

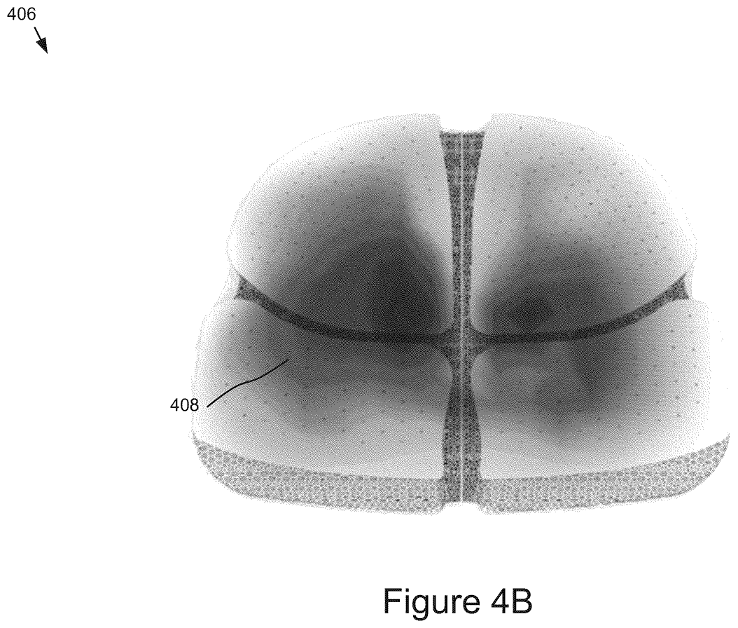

FIGS. 4A and 4B illustrate before and after pressure maps for a sitter that desired improved comfort in a seat rest due to injury. Specifically, FIG. 4A depicts an initial pressure map 400 generated using the seat rest sensor system 245 on a seat rest that includes a plurality of sensors that capture sensor data in accordance with an illustrative embodiment. In the mapping 402 of FIG. 4A, lighter shaded areas have lower pressure than the darker shaded areas. In an illustrative embodiment, each point of contact (as shown by the shading superimposed on the seat) in the mapping 402 is associated with a pressure value. The size of each point (or area) of contact depends on the resolution of the system, and can be in the range of one or more square microns, one or more square millimeters, etc.

The initial pressure mapping 402 of FIG. 4A was provided to the seat rest design application 235 along with pressure reduction goals associated with the sitter. The pressure reduction goals can be used to maximally reduce the peak pressure experienced by the sitter and to improve the sitter's weight distribution on the seat rest. The seat rest design application 235 can use this information to generate a lattice design for a seat rest in accordance with the pressure reduction goals. The lattice design can be used to 3D print a seat rest base, and the seat rest sensor system 245 can be placed on the printed seat rest base such that pressure between the sitter and seat rest could again be measured. FIG. 4B depicts the pressure map 406 for a seat rest designed using the seat rest design application 235 based on pressure reduction goals in accordance with an illustrative embodiment. As shown by the shading in FIG. 4B, in this example implementation, the printed seat rest resulted in a 39% reduction in peak sitter-seat rest pressure and increased weight distribution of the sitter over the contact areas of the seat rest.

In addition to individually customized seat rests, the proposed system can also generate seat rest that are intended to increase the comfort level for groups of sitters. Seat rest data used to generate such seat rests can come from the seat rest sensor system 245 and/or direct sitter feedback from a plurality of users. The seat rest design application 235 can also use seat rest data from sources other than the seat rest sensor system 245 to generate the lattice design. For example, the seat rest data can be representative of desired sitter-seat rest pressure values for a given type of sitter. This seat rest data can be generated based on feedback from sitters, based on testing, based on known problem areas of a given seat, etc. The seat rest data can be stored in the seat rest database 250, the memory 215, or elsewhere, and can be provided to the seat rest design application 235 for the generation of seat rest designs that are intended to accommodate groups of sitters.

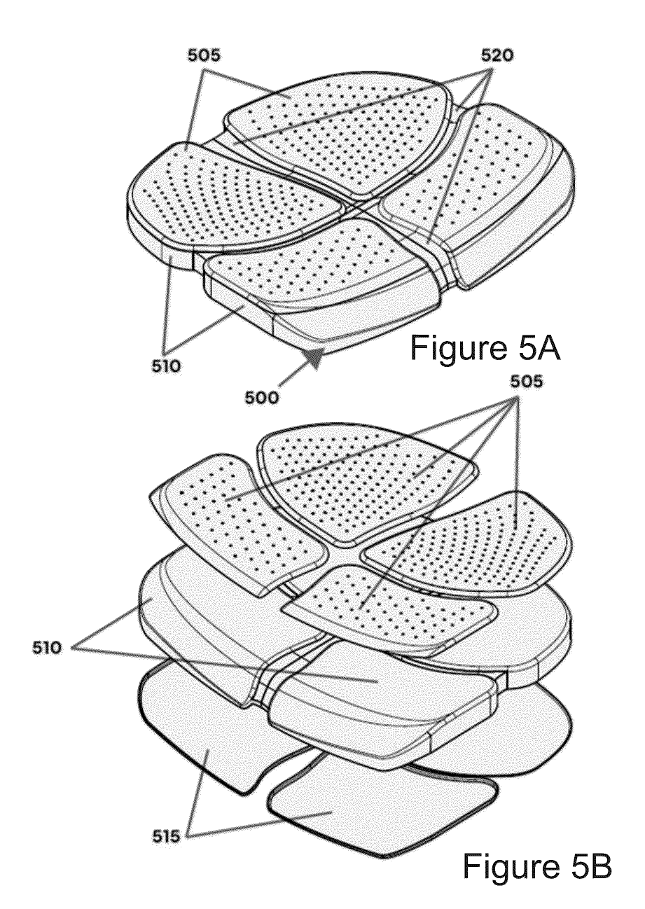

In an illustrative embodiment, the seat rest can be divided into different zones, and seat compliance can be considered on a zone-by-zone basis. Different zones can be of importance to different sitters, depending on sitting style, injury history, recent surgery, etc. FIGS. 5A and 5B depicts a seat 500 divided into zones 505 in accordance with an illustrative embodiment. The seat includes a top zone 505, a body zone 510, an bottom zone 515, and an connect zone 520. In alternative embodiments, a different number and/or shape/size of zones may be used. In another alternative embodiment, the seat rests may be designed and manufactured without the use of zones.

In an illustrative embodiment, the compliance of the zones depicted in FIGS. 5A and 5B can be controlled to design seat rests that are effective and comfortable for individuals and for large groups of sitters as a whole. For example, a seat rest for an intermediate sitter who sits in the middle of the seat rest can be designed with the top zone 505 as the softest zone for the seat 500, which in some example may have a compliance of ~9 N/mm². The body zone 510 can be designed to have intermediate hardness, which in some example may have a compliance of ~12 N/mm², while the bottom zone 515 can be designed to be the hardest portion of the seat, which in some example may have a compliance of ~18 N/mm². In alternative embodiments, different compliance values and/or zones may be used. For example, the compliance value in each zone can be adjusted up or down for different individuals and groups of sitters to maximize comfort and support. In one embodiment, the connect zone 520 can be the stiffest zone to provide support to the bone structure of the sitter and to create a cup that can receive and adapt to the bone structure of the sitter. In alternative embodiments, portions of one or more other zones may be stiffer than the connect zone 520 in the case of sitters with injury, pain, recent surgery, etc.

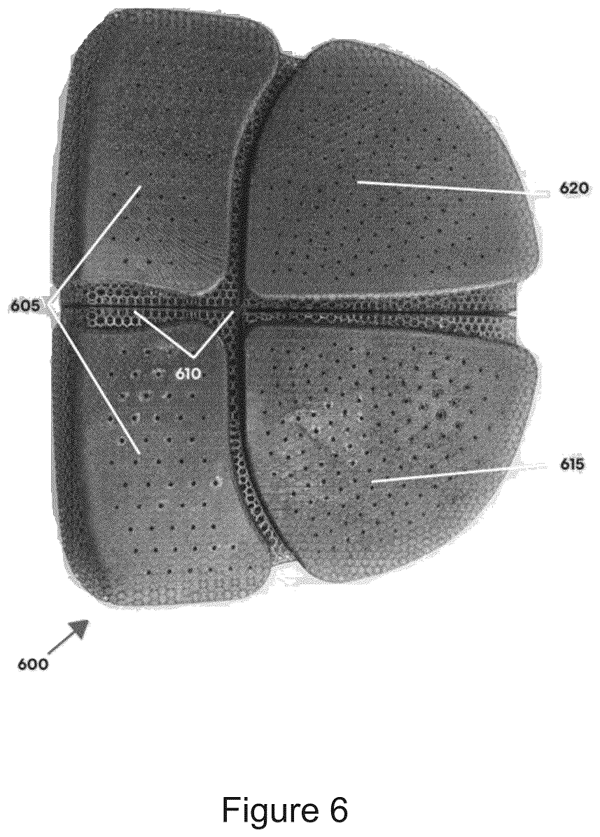

In one embodiment, a seat rest can be designed based on customized compliance zones that are specific to a given sitter or group of sitters. For example, due to an existing condition, a sitter may desire to have a seat rest with one or more cutouts that eliminate (or virtually eliminate) pressure between the sitter and the seat rest at various areas that would otherwise be points of contact. The one or more cutouts can form a zone that is used in conjunction with other zones to design a functional seat rest. As an example, FIG. 6 depicts a seat rest 600 with custom compliance zones in accordance with an illustrative embodiment. As shown, the seat rest 600 includes a front zone 605, a cutout zone 610, a first edge zone 615, and a second edge zone 620. The cutout zone 610 represents the area in which the sitter (or group of sitters) wishes to eliminate (or at least minimize) pressure between the sitter and the seat rest 600. In alternative scenarios, a different size, shape, and/or location of the cutout zone may be desired. Using the proposed system, a seat rest 600 can be designed with minimized pressure (i.e., maximized compliance) in the cutout zone 610 using the techniques described herein.

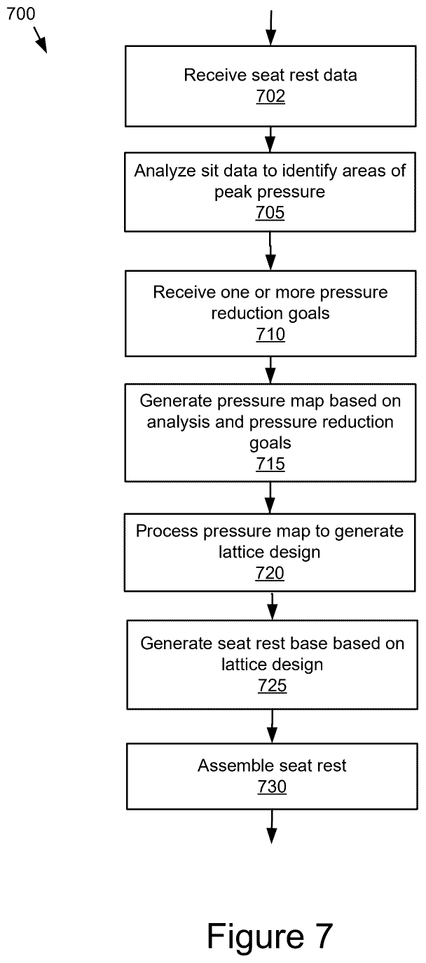

FIG. 7 is a flow diagram depicting operations performed to make a seat rest in accordance with an illustrative embodiment. In alternative embodiments, fewer, additional, and/or different operations may be performed. Additionally, the use of a flow diagram is not meant to be limiting with respect to the order of operations performed. In one embodiment, the operations of FIG. 7 can be performed by components of the seat rest design system 200 described herein with reference to FIG. 2. Alternatively, a different system may be used.

In an operation 700, the system receives seat rest data. The seat rest data can include compliance data that represents sitter-seat pressure that occurs as a result of contact between the sitter and the seat rest. In some embodiments, the seat rest data can include pressure data from the seat rest sensor system 245. The seat rest data can also include the amount of seat rest displacement that occurs due to the pressure. The pressure data can include static pressure data (i.e., pressure that occurs while the sitter is not moving) and moving pressure data (i.e., pressure that occurs while the sitter is moving). In some implementations, the compliance in the various zones of the seat rest is almost linear in nature. In one embodiment, the system can approximate compliance as a linear equation that relates a y-axis (load in Newtons) to an x-axis (displacement in mm).

The seat rest data can also include information regarding the type of seat rest that was used to generate the seat rest data, the materials from which the seat rest was made, the size and style of the seat rest, the size of the sitter, the sitting style of the sitter, etc. The seat rest data can be received from direct sitter input that is entered through an interface of the system, from local storage, from a remote database, from a sensor system that detects the pressures, etc. In one embodiment, the seat rest data can be obtained based on use of a sensor system in conjunction with a robot (or other mechanical device) that is used to imitate the interaction between the seat rest and the sitter such that the seat rest data is generated.

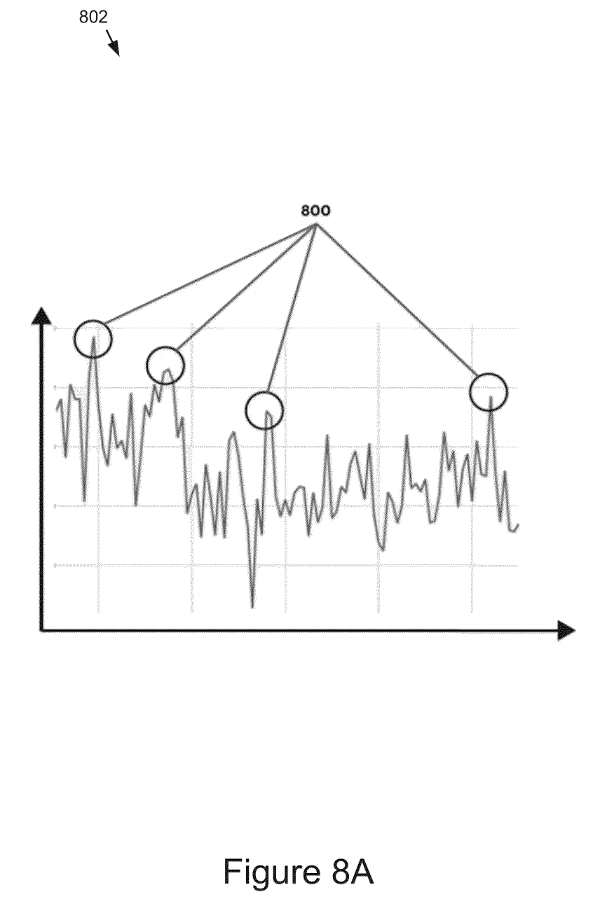

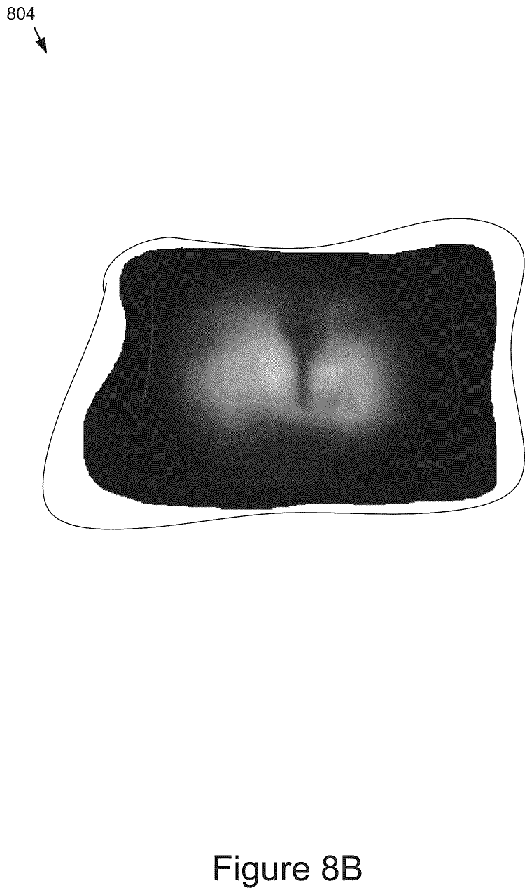

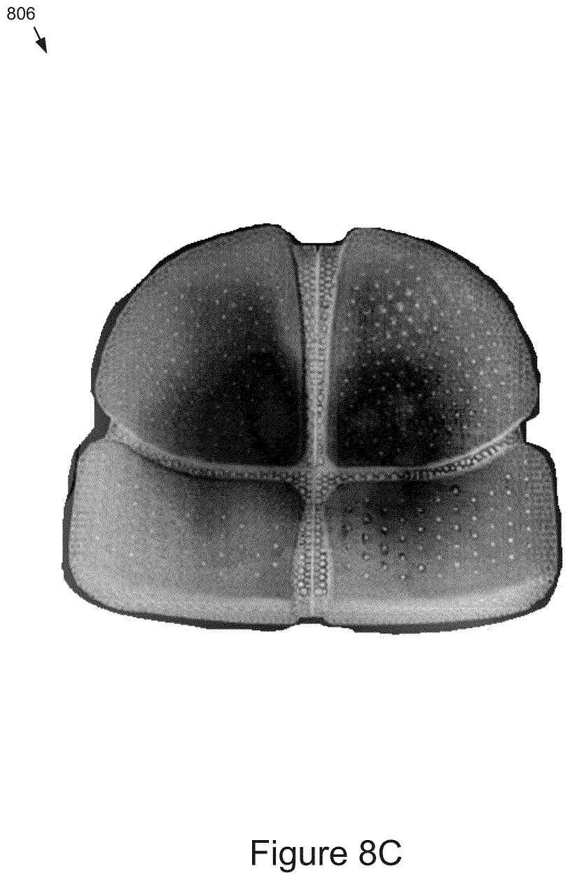

In an operation 705, the system analyzes the seat rest data to identify one or more areas of peak pressure. The system can also further analyze the seat rest data to determine the median of the peak pressure values, smooth the pressure data, convert the seat rest data into another format, etc. For example, in one embodiment, the system can filter the pressure data to remove outliers and smooth the dataset. FIG. 8A is a plot 802 that depicts median peak values of pressure 800 extracted from seat data in accordance with an illustrative embodiment. Extraction of the peak pressure values can be done separately for each zone of the seat rest, or for the seat rest as a whole, depending on the embodiment. In an alternative embodiment, the peak pressure values can be extracted from the seat rest data without generation of a plot.

In an operation 710, the system receives one or more pressure reduction goals. The pressure reduction goal(s) can be automatically generated by the system in one embodiment. Alternatively, the pressure reduction goal(s) can be specified by a sitter and/or a seat rest specialist, received from a local memory, received from a remote database, automatically generated by the system, etc. As an example of reduction goals, the system can aim to achieve an X% reduction in pressure for one or more peak pressures identified in each of a plurality of seat rest zones, where X can be 1, 2, 5, 10, 15, 20, 40, 50, etc. In some embodiments, the pressure reduction goal can also be to minimize or even increase the pressure in a given zone or other area of the seat rest. In some embodiments, the pressure reduction goal can also be in terms of a pressure value such as a decrease of 2 N/mm² at a first location of the seat rest, a decrease in pressure of 4 N/mm² at a second location of the seat rest, etc. The pressure reduction goals can also be determined automatically based on predetermined pressure thresholds that are to not be exceeded. Each different area or zone of the seat rest can have a different threshold. If this threshold is exceeded in a given area, the system can generate a pressure reduction goal for that area that brings the pressure to within the threshold in the seat rest design.

In an operation 715, the system generates a pressure map based on the analysis. The pressure map can include the pressure at every point of contact between the sitter and the seat rest, and can map that data to the position on the seat rest where the contact occurred. The pressure map can be broken down into separate zones of the seat rest in some embodiments. Also, the pressure map can be based on any number of pressure data points, such as 500 pressure readings, 1000 pressure readings, 1440 pressure readings, 2500 pressure readings, etc. FIG. 8B depicts a pressure map 804 in accordance with an illustrative embodiment. FIG. 8C depicts the pressure map of FIG. 8B superimposed 806 on a seat rest in accordance with an illustrative embodiment.

In an alternative embodiment, the system can also design seat rests based on desired amounts of pressure in each different zone or area of the seat rest. Such seat rest design can be done independent of any actual pressure readings and does not involve pressure reduction goals. Rather, in such an embodiment, the seat rest data can be desired pressure values for each of a plurality of areas of the seat rest, and the system can generate a seat rest design that satisfies the desired pressure values.

In an operation 720, the system processes the pressure map to generate a lattice design for a seat rest. In an alternative embodiment, the system may not generate a pressure map, and can instead utilize raw data (i.e., the raw pressure data and pressure reduction goals) to generate the lattice design. In another alternative embodiment, the pressure map can be based on actual or desired sitter-pressure data, and the system can process the pressure map and any pressure reduction goals to generate the lattice design. In such an embodiment, the pressure reduction goals are not incorporated into the pressure map.

The lattice design can be generated using the iterative design process described herein and/or any other data processing techniques. In an illustrative embodiment, data from the pressure map drives generation of the lattice design along with pressure reduction goals. As discussed herein, the lattice design may be in the form of interconnected ribs (or struts) that form interconnected polygons and/or other shapes such as circles, ovals, etc. The compliance of the lattice design is controlled based in part on the hardness and flexibility of the material used to form the seat rest. Specifically, taking the hardness and flexibility of the material into consideration, the system controls the thickness (e.g., diameter), orientation, cross-sectional profile, and/or length of the ribs to impart the desired amount of compliance in the seat rest based on the seat rest data and the pressure reduction goals. The lattice can also be generated based in part on the hardness/flexibility of a seat rest shell to which the lattice seat rest base is to be mounted, based on the suspension of the seat rest system, based on a type of cover to be placed over the lattice, etc. The lattice can be generated on a zone-by-zone basis in one embodiment.

In an operation 725, the system generates a seat rest base based on the lattice design. In an illustrative embodiment, the lattice design is in the form of 3D printer instructions that instruct a 3D printer how to print the seat rest base. The seat rest base can be a mesh lattice as described herein. The seat rest base can be printed as a 3D base or a two-dimensional (2D) base, depending on the implementation. A 2D seat rest base refers to a flat lattice structure that is later formed around and mounted onto a seat rest shell. A 3D seat rest base refers to a preformed lattice structure that is constructed in the proper shape to directly mount onto the seat rest shell without further forming/shaping.

The material used to form the seat rest can be an elastomeric polyurethane (EPU) (e.g., EPU44), a thermoplastic polyurethane (TPU) (e.g., TPU1301), or any other type of 3D printer material known in the art. In alternative embodiments, a different TPU material, a different EPU material, or a different type of material may be used to form the seat rest. In some implementations, the ribs which make up the lattice have differing thicknesses, different lengths, and interconnect to form different types and sizes of polygon shapes depending on where they are positioned in the 3D lattice. This variation in ribs extends throughout the 3D structure and controls the compliance of the seat rest lattice at each position thereof.

Referring again to FIG. 7, the seat rest may be assembled in an operation 730. The assembly can include mounting the seat rest base to a seat rest shell, mounting the seat rest shell to seat rest rails, and/or placing a cover over all or a portion of the seat rest base. In embodiments in which the seat rest base is a 2D lattice, assembly can also include forming the seat rest base to fit the seat rest shell. The 2D lattice can be formed using heat molding, baking, or any other techniques known in the art. During assembly, the seat rest base (or lattice) can be mounted to a seat rest shell, which can be made from nylon, carbon, composite material, etc. An adhesive such as contact cement or cyanoacrylate can be used to secure the seat rest base to the seat rest shell.

In some embodiments, the seat rest shell can be wrapped with a material to cover the appearance of the lattice. The cover material can affect the compliance of the seat rest, and in some embodiments, this effect from the cover can be taken into consideration during the lattice design operation. The cover, if used, can help protect the seat rest from the elements and also from insects. The cover can be applied to the seat rest shell using either a positive vacuum or a negative vacuum, depending on the embodiment. For a positive vacuum process, the cover material is vacuum formed over the lattice and simultaneously bonded to the shell. For a negative vacuum process, the cover material is vacuum formed into a cavity and the lattice is placed into the cavity and bonded to the cover material. The cover can be secured to the seat rest shell using contact cement, a 2-part urethane, or another adhesive that will not significantly alter the compliance values of the lattice. The cover can also be wrapped onto the seat rest shell and adhered to the seat rest shell using contact cement or another adhesive. The cover can be a clear or colored TPU material, polyurethane soft-touch material, or other material.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

The following are optional features of the disclosed seat design system.

Optionally, the one or more sitter-seat pressure values comprise desired pressure values for a plurality of seat zones.

Optionally, the seat design system further comprises a transceiver operatively coupled to the processor, wherein the transceiver is configured to receive at least a portion of the seat data from a seat sensor system.

Optionally, the seat data includes sitter height, sitter weight, or sitter size.

Optionally, analysis of the one or more sitter-seat pressure values identifies an area of peak pressure. Optionally, the processor determines whether the area of peak pressure exceeds a pressure threshold. Optionally, the processor generates a pressure reduction goal for the area of peak pressure that exceeds the pressure threshold, wherein the processor uses the pressure reduction goal to generate the lattice design with reduced pressure at the area of peak pressure, and wherein the reduced pressure is within the pressure threshold.

Optionally, the processor is configured to generate a pressure map based at least in part on the analysis of the one or more sitter-seat pressure values.

Optionally, generation of the lattice design includes generation of instructions for a three-dimensional (3D) printer to print the lattice design. Optionally, the seat design system further comprises the 3D printer, wherein the 3D printer is configured to print the lattice design to generate the seat base.

Optionally, to generate the lattice design the processor determines a thickness of ribs that form the lattice design.

Optionally, to generate the lattice design the processor determines a length of ribs that form the lattice design.

Optionally, to generate the lattice design the processor determines a type of shape that is to be formed by interconnected ribs that form the lattice design. Optionally, to generate the lattice design the processor determines a size of an opening in the type of shape formed by the interconnected ribs that form the lattice design.

Optionally, the seat data includes a type of material used to form a seat shell to which the seat base is to be mounted, and wherein the lattice design is generated based at least in part on the type of material.

The following are optional features of the seat rest.

Optionally, at least a portion of the first plurality of interconnected ribs form a first plurality of shapes having first openings, and wherein at least a portion of the second plurality of interconnected ribs form a second plurality of shapes having second openings.

Optionally, the first openings differ in size from the second openings.

Optionally, the first plurality of shapes are of a different type than the second plurality of shapes.

Optionally, a first portion of the first plurality of interconnected ribs form a first plurality of shapes having first openings, wherein a second portion of the first plurality of interconnected ribs form a second plurality of shapes having second openings, and wherein the first openings differ in size from the second openings.

In another implementation, the chair 10 may be a multi-zonal sitting structure where the chair 10 may include a seat rest base on which a seat rest lattice structure 9 is positioned. The seat rest base may also include one more leg supports connected to a bottom surface of the seat rest base to support the seat rest base. The seat rest lattice structure 9 may be used to create different (e.g., multi-zonal) sitting pressures within the lattice structure. In some implementations, the seat rest lattice structure 9 may be printed as described elsewhere herein and formed out of materials as described elsewhere herein. The seat rest lattice structure 9 may use the different zones to create different pressures at different points in order to provide a more comfortable and/or a customized sitting position for a user using the chair or multi-zonal sitting structure.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus or software communication mechanism.

Some embodiments can take the form of an entirely hardware embodiment, an entirely software embodiment or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code can include at least one processor coupled directly or indirectly to memory elements through a system bus or software communication mechanism. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A seat rest design system comprising:
a memory configured to store seat rest data, wherein the seat rest data includes one or more sitting pressure values; and
a processor operatively coupled to the memory, wherein the processor is configured to:
analyze the one or more sitting pressure values; and
generate a lattice structure design for a seat rest base using the analysis of the one or more sitting pressure values, the lattice structure design being configured to provide additional support in portions of the lattice structure design based on the sitting pressure values.

2. The seat rest design system of claim 1, wherein the one or more sitting pressure values comprise desired pressure values for a plurality of seat rest zones.

3. The seat rest design system of claim 2, further comprising a transceiver operatively coupled to the processor, wherein the transceiver is configured to receive at least a portion of the seat rest data from a seat rest sensor system.

4. The seat rest design system of claim 1, wherein analysis of the one or more sitting pressure values identifies an area of peak sitting pressure.

5. The seat rest design system of claim 4, wherein the processor determines whether the area of peak sitting pressure exceeds a pressure threshold.

6. The seat rest design system of claim 5, wherein the processor generates a pressure reduction goal for the area of peak sitting pressure that exceeds the pressure threshold, wherein the processor uses the pressure reduction goal to generate the lattice structure design with reduced pressure at the area of peak sitting pressure, and wherein the reduced pressure is within the pressure threshold.

7. The seat design system of claim 1, wherein the processor is configured to generate a pressure map based at least in part on the analysis of the one or more sitting pressure values.

8. The seat rest design system of claim 1, wherein generation of the lattice structure design includes generation of instructions for a three-dimensional (3D) printer to print the lattice structure design.

9. The seat rest design system of claim 1, wherein to generate the lattice structure design the processor determines a thickness of one or more ribs that form the lattice structure design and a length of the one or more ribs that form the lattice structure design.

10. The seat rest design system of claim 1, wherein to generate the lattice structure design the processor determines a type of shape that is to be formed by interconnected ribs that form the lattice structure design, and wherein to generate the lattice structure design the processor determines a size of an opening in the type of shape formed by the interconnected ribs that form the lattice structure design.

11. A seat rest comprising:
a seat rest shell; and
a seat rest base mounted to the seat rest shell, wherein the seat rest base is in the form of a lattice structure that includes:
a first zone composed of a first plurality of interconnected ribs that result in a first peak sit pressure value for the first zone; and
a second zone composed of a second plurality of interconnected ribs that result in a second peak sit pressure value for the second zone that differs from the first peak sit pressure value.

12. The seat rest of claim 11, wherein at least a portion of the first plurality of interconnected ribs form a first plurality of shapes having first openings, and wherein at least a portion of the second plurality of interconnected ribs form a second plurality of shapes having second openings.

13. The seat rest of claim 12, wherein the first openings differ in size from the second openings.

14. The seat rest of claim 13, wherein the first plurality of shapes are of a different type than the second plurality of shapes.

15. The seat rest of claim 14, wherein a first portion of the first plurality of interconnected ribs form a first plurality of shapes having first openings, wherein a second portion of the first plurality of interconnected ribs form a second plurality of shapes having second openings, and wherein the first openings differ in size from the second openings.

16. A multi-zonal sitting apparatus comprising:
a seat rest base;
a seat rest lattice structure positioned on a top surface of the seat rest base, wherein the seat rest lattice structure is a 3D printed lattice with a first zone having a first sitting pressure and a second zone having a second sitting pressure; and
one or more leg supports connected to a bottom surface of the seat rest base to support the seat rest base.

17. The multi-zonal sitting apparatus of claim 16, wherein the seat rest lattice structure is 3D printed using a generated lattice structure design that includes a plurality of interconnected ribs forming the first zone and the second zone.

18. The multi-zonal sitting apparatus of claim 17, wherein the plurality of interconnected ribs form a first plurality of shapes having first openings, and wherein at least a portion of the second plurality of interconnected ribs form a second plurality of shapes having second openings.

19. The multi-zonal sitting apparatus of claim 16, wherein the first zone is designed to provide more support based on the first zone being identified as a higher pressure sitting area.

20. The multi-zonal sitting apparatus of claim 17, wherein the second zone is designed to provide less support compared to the first zone support based on the second zone being identified as a lower pressure sitting area.
